(19) United States
(12) Patent Application Publication
(10) Pub. No.: US 2023/0166416 A1
(43) Pub. Date: Jun. 1, 2023

(54) Razor Cartridge Seal

(71) Applicant: EDGEWELL PERSONAL CARE BRANDS, LLC, Chesterfield, MO (US)

(72) Inventor: Jochen Thoene, Pompton Lakes, NJ (US)

(21) Appl. No.: 17/998,935

(22) PCT Filed: May 13, 2021
(86) PCT No.: PCT/US2021/032205

§ 371 Date: Nov. 16, 2022

Related U.S. Application Data
(60) Provisional application No. 63/027,377, filed on May 20, 2020.

(51) Int. Cl. B26B 21/22; B26B 21/40

(52) U.S. Cl. CPC B26B 21/222; B26B 21/4018

(57) ABSTRACT

A razor cartridge has a housing with a blade mounting region between a guard and a cap. A first and a second razor blade are sequentially mounted in the blade mounting region with an intermediate non-cutting and skin engaging structure between the blades. The intermediate structure has a leading edge region closest the guard and at or adjacent a skin engaging surface of the intermediate structure. The leading edge region of the intermediate structure has an elastomeric linear seal contacting the first razor blade to seal any gap between the intermediate structure and the first blade.

### BACKGROUND

### 1. Technical Field

The present disclosure relates to safety razors in general and, more particularly, to razor cartridges having seals, especially an elastomeric seal.

### 2. Background

U.S. Pat. Application Publication 2006/0277759 generally discusses difficulties of rinsing shaving debris (including hair and skin particles, and shaving cream or other shaving preparations) from the space between adjacent blades of a typical multi-blade safety razor cartridge. This document generally acknowledges debris that remains in the space between the blades can negatively affect the performance of the razor cartridge because the skin of the surface to be shaved is prevented from entering the space between the two or more blades during normal shaving. Furthermore, debris can clog and accumulate to a degree that the space is over-filled, and the skin surface being shaved can be pushed away from the cutting edges of the blades. Accumulated debris can also be visually undesirable to a user.

U.S. Pat. Application No. 2011/0146079 discloses an intermediate non-cutting and skin-supporting element between blades, and where a rinse through gap from the intermediate element to an adjacent structure can range in width from 0.05 mm. Typical beard hair (terminal hair) of a male user is about 0.1 mm diameter and has a growth rate about 0.4 mm per day. Wet shaving typically cuts some hair shafts at an acute angle to the length axis thus yielding hair debris particles that can undesirably clog small gaps. Such gaps are also difficult to rinse from an opposed end of the gap.

The previously-mentioned ‘759 application further discusses the dilemma between the wish to reduce the tip-to-tip span (that can also be considered as a spacing between a blade and a non-cutting element) in order to increase comfort and the desire to widen the spacing in order to achieve greater rinsibility.

The present applicant has discovered that it can be preferable to completely eliminate a small dimension rinse gap rather than provide such an easily clogged gap. Further complicating this desire, blade structures of many modem wet shaving cartridges are not entirely flat or straight. Such blade structures can include blades on bent supports and so-called bent blades. U.S. Pat. No. 5,010,646 acknowledges and dimensionally defines some distortions.

### SUMMARY

The present disclosure has for its objective to substantially alleviate the limitations of the prior art razor cartridges by providing an intermediate inter-blade structure with an elastomeric (resilient) seal to entirely close any gap between the intermediate structure and a preceding razor blade structure.

A razor cartridge has a housing with a guard at a front region of the housing, a cap at a rear region of the housing, and opposed end walls connecting the guard and the cap. The housing defines a blade mounting region between the guard and the cap. A first razor blade closest the guard, and a second razor blade are both mounted in the blade mounting region, with the cutting edges of both razor blades facing the guard. An intermediate non-cutting and skin engaging structure is between the first and the second razor blade, the intermediate structure has a leading edge region closest the guard and at or adjacent a skin engaging surface of the intermediate structure. The leading edge region has an elastomeric linear seal contacting the first razor blade.

In other aspects of the present disclosure: the intermediate structure is integrally formed with the housing; the linear seal extends along the leading edge region entirely between the opposed end walls; an interface between the intermediate structure and a trailing edge of the linear seal is castellated; the linear seal is co-formed with an elastomeric structure of the guard; the linear seal comprises a mixture of a thermoplastic elastomer and a hydrophilic polymer.

In further aspects the intermediate structure can comprise a plurality of platforms that can be cantilevered. A gap between adjacent platforms can reduce in width in a front to rear direction of the cartridge, e.g. to a rear gap width of 0.1 mm.

In more further aspects a rear region of the guard can be provided with gaps.

The linear seal seals any gap between the intermediate structure and the first razor blade, that may not be flat or straight. Undesirable clogging of a gap that might be small is avoided as any gap is sealed. The linear seal can include a lubricious hydrophilic polymer for wet frictional benefits in use.

The above features and advantages will be more fully understood with reference to the following detailed description when taken in conjunction with the accompanying drawings.

### BRIEF DESCRIPTION OF THE DRAWINGS

FIG. 1 is an upper isometric view of a razor cartridge of the present disclosure;

FIG. 2 is a transverse sectional view of the cartridge;

FIG. 3 is a transverse sectional view of another razor blade structure.

FIG. 4 is an upper isometric view of another razor cartridge;

FIG. 5 is a detailed view of a portion of the cartridge of FIG. 4; and

FIG. 6 is a plan view of the portion of FIG. 5.

### DETAILED DESCRIPTION

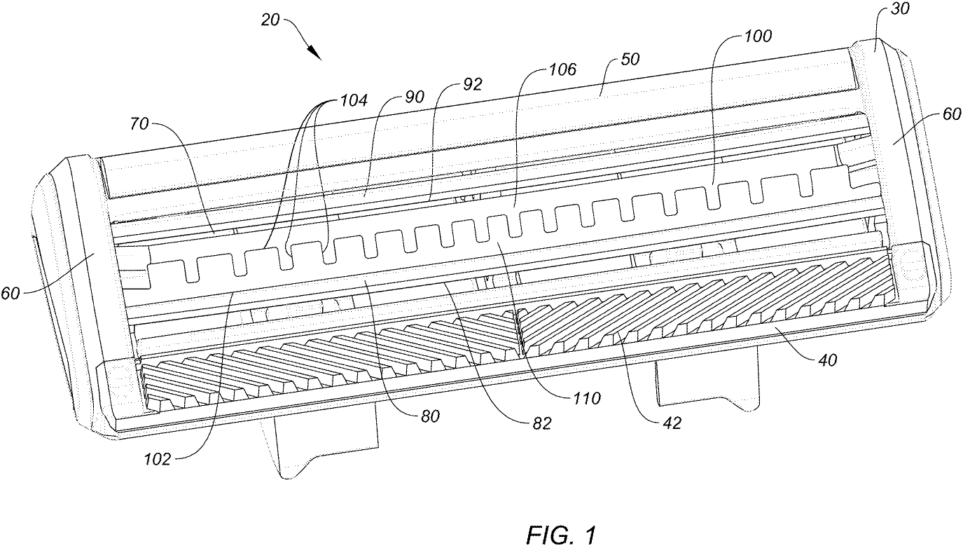

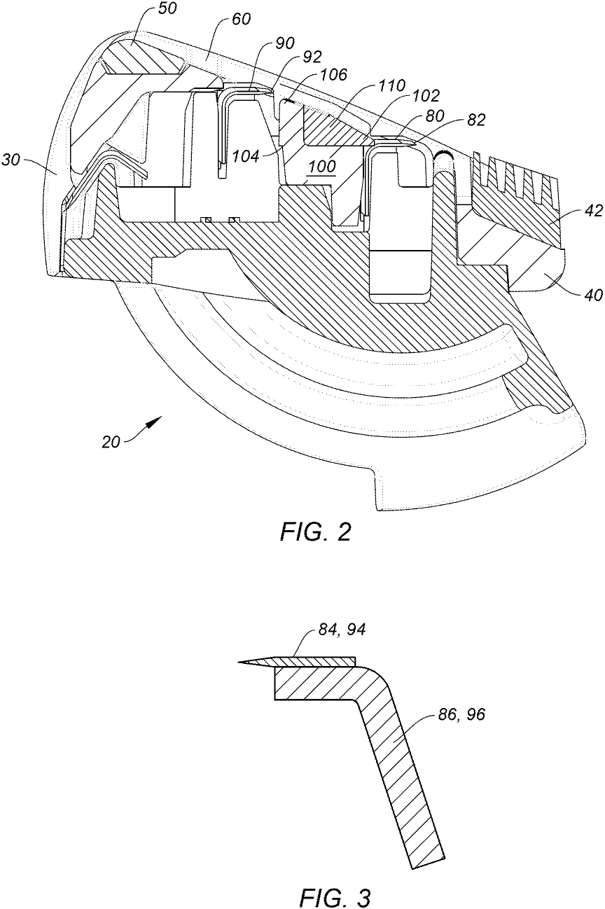

Referring now to the drawings and in particular FIGS. 1 and 2, a razor cartridge 20 is depicted, having a housing 30 with a guard 40 at a front region of the housing 30 and a cap 50 at a rear region of the housing 30. In the context of the present disclosure the terms front, forward, leading etc., and rear, aft, trailing etc. are used relative to a direction of motion of the razor cartridge 20 in use. The housing has opposed end walls 60 connecting the guard 40 and cap 50. The housing defines a blade mounting region 70 between the guard 40 and the cap 50. A first razor blade 80, closest the guard 40, and a second razor blade 90 are mounted in the blade mounting region 70. Cutting edges 82, 92 respectively of both blades 80, 90 face forward, toward the guard 40.

The housing 30 is manufactured by injection molding a suitable thermoplastic polymer such as ABS (acrylonitrile butadiene styrene).

An intermediate non-cutting and skin engaging structure 100 is positioned in the blade mounting region 70 between razor blades 80 and 90. The intermediate element 100 is preferably integrally formed with the housing 30, more particularly integrally formed with the end walls 60. The intermediate structure 100 has a leading edge region 102 closest the guard 40 and at or adjacent a skin engaging surface 106 of the intermediate structure 100. The leading edge region 102 has an elastomeric linear seal 110 contacting the first razor blade 80. The linear seal 110 preferably extends completely between the opposed end walls 60. An interface 104 between the intermediate structure 100 and a trailing edge 112 of the linear seal 110 is castellated. Relative to a straight interface, this effectively increases the area of contact between the intermediate structure 100 and the linear seal 110 to enhance the joint strength therebetween.

The guard 40 includes an elastomeric portion 42, e.g. a finned structure as depicted, and as will be known to the skilled worker. Preferably the linear seal 110 is co-molded with the elastomeric guard portion 42. Suitable elastomeric polymers (TPEs) of the linear seal 110 (and elastomeric guard portion 42) have a Shore A hardness range between 28 and 65 Shore A, preferably between 35 and 45 Shore A. A suitable material is THERMOLAST K TF6 manufactured by Kraiburg. This material is chosen for benefits including a preferred joint strength when co-molded with ABS. The TPE of the linear seal 110 can include a hydrophilic polymer such as polyethylene oxide (PEO) for wet friction benefits in use.

In FIG. 2 the razor blades 80, 90 depicted are so-called bent blades. In FIG. 3 a satisfactory alternative blade structure of a respective first and second flat razor blade 84, 94 on a respective bent support 86, 96 is shown.

The linear seal 110 seals any gap between the intermediate non-cutting and skin engaging structure 100 and the first razor blade 80, or equivalently between the skin engaging structure 100 and the first flat razor blade 84 on its bent support 86. Since the linear seal is formed from an elastomeric material it can conform to irregularities along the length of the razor blade 80.

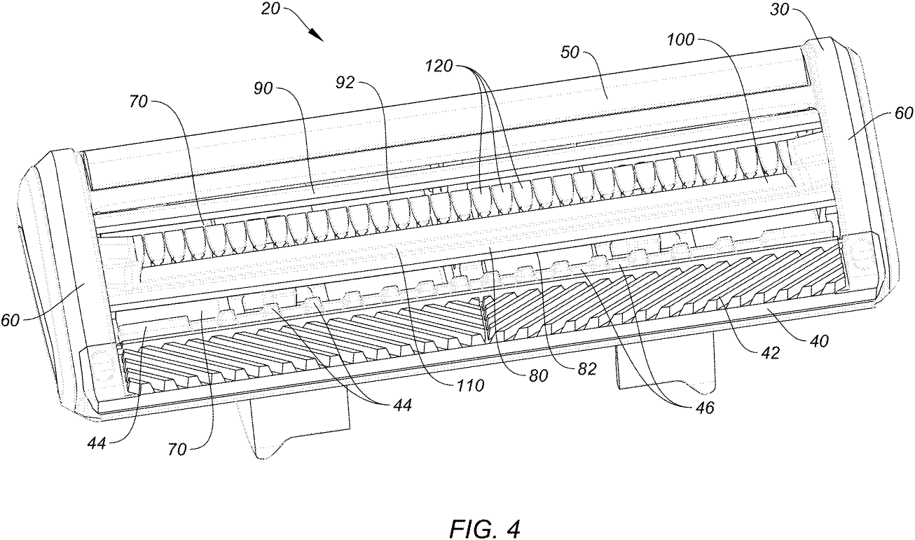

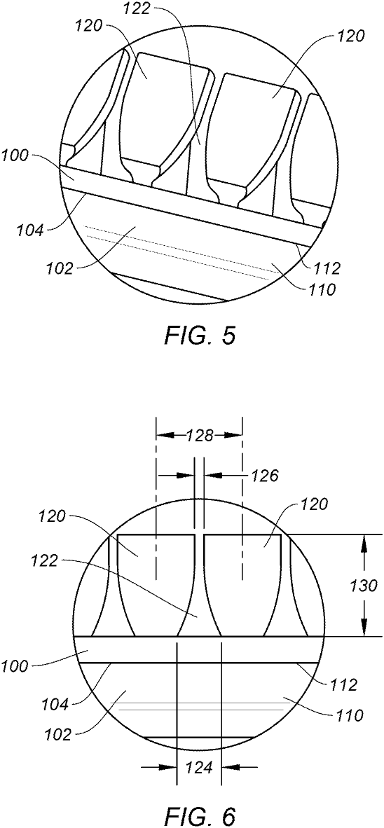

In FIGS. 4-6 another razor cartridge is depicted, similar features having the same reference numbers as the cartridge of FIG. 1. The razor cartridge 20 has a housing 30 with a guard 40 at a front region of the housing 30 and a cap 50 at a rear region of the housing 30. The housing has opposed end walls 60 connecting the guard 40 and cap 50. The housing defines a blade mounting region 70 between the guard 40 and the cap 50. A first razor blade 80, closest the guard 40, and a second razor blade 90 are mounted in the blade mounting region 70. Cutting edges 82, 92 respectively of both blades 80, 90 face forward, toward the guard 40. An intermediate non-cutting and skin engaging structure 100 is positioned in the blade mounting region 70 between razor blades 80 and 90. The intermediate element 100 is preferably integrally formed with the housing 30, more particularly integrally formed with the end walls 60. The intermediate structure 100 has a leading edge region 102 closest the guard 40 and at or adjacent a skin engaging surface 106 of the intermediate structure 100. The leading edge region 102 has an elastomeric linear seal 110 contacting the first razor blade 80. The linear seal 110 preferably extends completely between the opposed end walls 60. An interface 104 is between the intermediate structure 100 and a trailing edge 112 of the linear seal 110. Preferably the linear seal 110 is co-molded with the elastomeric guard portion 42. In this cartridge 20 the intermediate element 100 is provided with a plurality, e.g. total thirty one cantilevered platforms 120 (see especially FIGS. 5 and 6) having a gap 122 between adjacent platforms 120. As depicted the gap 122 can reduce in width in a front to rear direction of the razor cartridge 20. For example a front width 124 of the gap 122 can be 0.5 mm and a rear width 126 can be 0.1 mm. A pitch 128 of the platforms 120 can be 1.0 mm and a front to rear length 130 of the platforms can be 1.2 mm. Gaps 122 can align and prepare hairs to be cut by the cutting edge 92 of the second razor blade 90. That is, since typical beard hairs can be 0.1 mm diameter the hairs can be lightly gripped between adjacent platforms 120 and lightly pulled or extended from their respective follicle in advance of the second cutting edge 92.

A shaving geometry defining rail 44 at a rear region of the guard 40 can also be provided with gaps 46.

While various embodiments have been described above it should be understood that they have been presented by way of example only, and not limitation. For instance, modifications or changes as can be made within the scope of the attached claims and features disclosed in connection with any one embodiment can be used alone or in combination with each feature of the respective other embodiments. Thus, the breadth and scope of any embodiment should not be limited by any of the above described exemplary embodiments but should be defined only in accordance with the following claims and their equivalents.

1. A razor cartridge, comprising:
a housing having a guard at a front region of the housing, a cap at a rear region of the housing, and opposed end walls connecting the guard and the cap, the housing defining a blade mounting region between the guard and the cap;
a first razor blade closest the guard, and a second razor blade both mounted in the blade mounting region, the cutting edges of both razor blades facing the guard; and
an intermediate non-cutting and skin engaging structure between the first and the second razor blade, the intermediate structure having a leading edge region closest the guard and at or adjacent a skin engaging surface of the intermediate structure, the leading edge region having an elastomeric linear seal contacting the first razor blade.

2. The razor cartridge of claim 1, wherein the intermediate structure is integrally formed with the housing.

3. The razor cartridge of claim 1, wherein the linear seal extends along the leading edge region entirely between the opposed end walls .

4. The razor cartridge of claim 1, wherein an interface between the intermediate structure and a trailing edge of the linear seal is castellated.

5. The razor cartridge of claim 1, wherein the linear seal is co-formed with an elastomeric structure of the guard.

6. The razor cartridge of claim 1, wherein the intermediate structure comprises a plurality of platforms.

7. The razor cartridge of claim 6, wherein the platforms are cantilevered.

8. The razor cartridge of claim 6, wherein a gap between adjacent platforms reduces in width in a front to rear direction of the cartridge.

9. The razor cartridge of claim 8, wherein a rear gap width is 0.1 mm.

10. The razor cartridge of claim 1, wherein a rear region of the guard is provided with gaps.

11. The razor cartridge of claim 1, wherein the linear seal comprises a mixture of a thermoplastic elastomer and a hydrophilic polymer.
